(19) United States
(12) Patent Application Publication
(10) Pub. No.: US 2008/0008424 A1
(43) Pub. Date: Jan. 10, 2008

(54) Optical low pass filter and camera

(75) Inventor: Yasuo Shimizu, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/822,255

(22) Filed: Jul. 3, 2007

(30) Foreign Application Priority Data
Jul. 7, 2006 (JP) 2006-188145

(51) Int. Cl. G02B 6/26

(52) U.S. Cl. 385/51

(57) ABSTRACT

An optical low pass filter and a camera that are capable of preventing Moire effects over continuous wavelength ranges without depending on the wavelength of the light are provided.

A first wave plate and a second wave plate are provided between a first birefringent plate and a second birefringent plate. The optical axis of the first wave plate and the optical axis of the second wave plate are orthogonal within a plane orthogonal to a traveling direction of an optical path. A thickness difference Δd between the first wave plate and the second wave plate in a direction of the optical path satisfies the equation Δd≈λ/(4*Δn), where a difference between a refractive index of ordinary ray and a refractive index of extraordinary ray of the first wave plate and the second wave plate is Δn and a central wavelength of a wavelength range of use is λ.

The disclosure of the following priority application is herein incorporated by reference: Japanese Patent Application No. 2006-188145 filed on Jul. 7, 2006.

### BACKGROUND OF THE INVENTION

1. Field of the Invention

The present invention relates to an optical low pass filter provided on an optical path so as to be closer to a subject than an image pickup device and capable of preventing such as Moire effects, and a camera provided therewith.

2. Description of Related Art

Conventionally, digital still cameras, digital video cameras, and the like typically pick up an image using an image pickup device such as a CCD (Charge Coupled Devices) or a CMOS (Complementary Metal Oxide Semiconductor). Such an image pickup device includes light receiving pixels that are regularly arranged, and accordingly, Moire fringes or false color (color Moire) or the like (hereinafter collectively referred to as Moire effects) may occur. Thus, in order to prevent Moire effects, an optical low pass filter is provided for the image pickup device on the side from which light enters.

One example of such an optical low pass filter provides a wave plate (quarter-wave plate) using a uniaxial crystal such as quartz between two birefringent plates to split incident light from a side of a subject into four beams, thereby preventing Moire effects.

This type of a wave plate is used for converting linearly polarized light into circularly polarized light. An ideal wave plate converts linearly polarized light into circularly polarized light regardless of the wavelength of the incident light. However, because the thickness of such an ideal wave plate becomes very thin when using quartz to form it, it has been difficult to make a plate of quartz thin enough to be used as an ideal quarter-wave plate without wavelength dependence. Therefore, conventionally, a quartz plate of a thickness that can be used as an optical low pass filter with a wavelength dependence that is relatively small without any noticeable effect has been used as a wave plate.

However, because the wavelength dependence is present in an effect of circular polarization with the wave plate of such a thickness, for light passing through a conventional optical low pass filter, one wavelength range (color) is split into four beams, while for other wavelength ranges the splitting into four beams is weak, and these are only split into approximately two beams, thus, a problem has been noted that Moire effects can easily occur in wavelength ranges where the light is not split into four beams.

Japanese Unexamined Patent Application Publication No. 2004-70340 describes an example in which a polymeric film such as a plastic film has been uniaxially stretched as a quarter-wave plate. However, there is a problem that such as a plastic film is lower in durability than the conventional quartz plate, and alteration and degradation can occur.

### SUMMARY OF THE INVENTION

An object of the present invention is to provide an optical low pass filter and a camera that are capable of preventing Moire effects in continuous wavelength ranges without depending on the wavelength of the light.

The present invention achieves the above object by the following solutions.

According to the first aspect of the present invention, an optical low pass filter is provided closer to a subject than an image pickup device along an optical path of a photographic optical system, and the optical low pass filter comprises: a first birefringent plate that is provided closest to the subject and that splits incident light into two light beams; a first wave plate and a second wave plate that are provided on a side closer to the image pickup device than the first birefringent plate, and that cause a phase difference between two components that are contained in the incident light and that have oscillation directions orthogonal to each other; and a second birefringent plate that is provided on a side closer to the image pickup device than the first wave plate and the second wave plate, and that splits the incident light into two beams.

According to the second aspect of the present invention, an optical low pass filter is provided closer to a subject than an image pickup device along an optical path of a photographic optical system, and the optical low pass filter comprises: a first birefringent plate that is provided closest to the subject and that converts incident light into approximately linearly polarized light; a first wave plate and a second wave plate that are provided on a side closer to the image pickup device than the first birefringent plate, and that convert the incident light into approximately circularly polarized light; and a second birefringent plate that is provided on a side closer to the image pickup device than the first wave plate and the second wave plate, and that converts the incident light into approximately linearly polarized light.

According to a third aspect of the present invention, an optical low pass filter is provided closer to a subject than an image pickup device along an optical path of a photographic optical system, and the optical low pass filter comprises: a first birefringent plate that is provided closest to the subject and that has an optical axis along a plane that is not orthogonal to a traveling direction of the optical path; a first wave plate and a second wave plate that are provided on a side closer to the image pickup device than the first birefringent plate, and each of which has an optical axis along a plane orthogonal to the traveling direction of the optical path; and a second birefringent plate that is provided on a side closer to the image pickup device than the first wave plate and the second wave plate, and that has an optical axis along the plane that is not orthogonal to the traveling direction of the optical path.

In the optical low pass filter according to the first, second and third aspects of the invention, the optical low pass filter may be such that the optical axis of the first wave plate and the optical axis of the second wave plate may be approximately orthogonal within a plane orthogonal to the traveling direction of the optical path.

In the optical low pass filter according to the first, second and third aspects of the invention, the optical low pass filter may be such that an equation Δd≈λ/(4*Δn) is satisfied, where the thickness difference between the first wave plate and the second wave plate in a direction of the optical path is Δd, the difference between refractive indexes of an ordinary ray and a refractive index of an extraordinary ray of the first wave plate and the second wave plate is Δn, and a central wavelength of a wavelength range of use is λ.

In the optical low pass filter according to the first, second and third aspects of the invention, the optical low pass filter may be such that the optical axis of the first birefringent plate and the optical axis of the first wave plate form an angle of approximately 45 degrees when viewed from the traveling direction of the optical path.

In the optical low pass filter according to the first, second and third aspects of the invention the optical low pass filter may be such that the first wave plate and the second wave plate are formed USING quartz, and the thickness difference between the first wave plate and the second wave plate in a direction of the optical path is approximately 15 μm.

According to a fourth aspect of the present invention, a camera comprises an optical low pass filter according to the first, second or third aspect of the invention.

According to the present invention, it is possible to provide an optical low pass filter and a camera that are capable of preventing Moire effects in continuous wavelength ranges without depending on the wavelength of the light.

### BRIEF DESCRIPTION OF THE DRAWINGS

FIG. 1 shows a cross-sectional view illustrating a camera according to the present embodiment;

FIG. 2 shows a perspective view illustrating a layer structure of an optical low pass filter and an optical axis of each layer in the layer structure;

FIG. 3 shows a diagram illustrating an angle of the optical axis of each layer of the optical low pass filter;

FIG. 4 shows a diagram illustrating the optical low pass filter according to the present embodiment and light that has passed through each layer;

FIG. 5 shows a diagram illustrating a phase difference caused by a wave plate used for an optical low pass of a comparison example, and subject light entering an image pickup device; and

FIG. 6 shows a diagram illustrating a phase difference caused by a first wave plate and a second wave plate used for the optical low pass filter of an example, and subject light entering an image pickup device.

### DETAILED DESCRIPTION OF THE INVENTION

The following describes an embodiment of the present invention in further detail with reference to the drawings. In the following embodiment, an example of a single-lens reflex camera is explained.

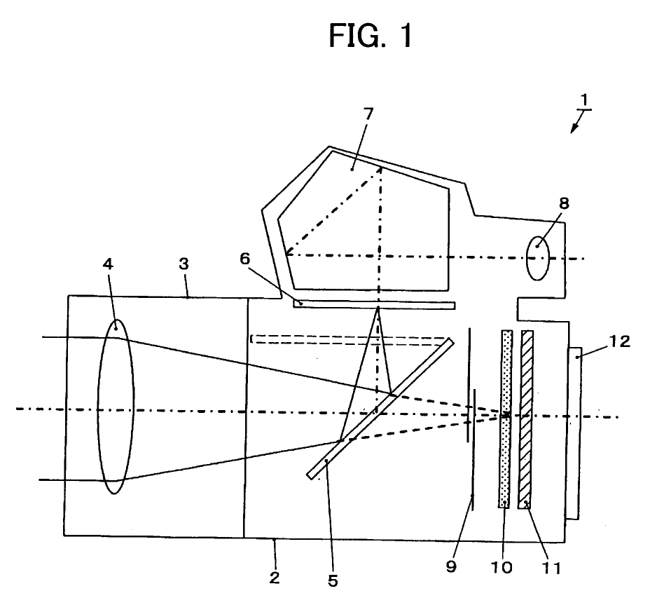

FIG. 1 shows a cross-sectional view illustrating a camera 1 according to the present embodiment.

The camera 1 according to the present embodiment is a single-lens reflex camera in which an interchangeable lens 3 is detachably provided on a camera body 2.

The interchangeable lens 3 includes a photographic lens 4 that constitutes a photographic optical system, and is detachably provided on the subject side (left side in FIG. 1) of the camera body 2. The camera body 2 is provided with a mirror unit 5, a viewfinder screen 6, a pentaprism 7, an ocular optical system 8, a shutter 9, an optical low pass filter 10, an image pickup device 11, a display screen 12, and the like.

The mirror unit 5 is also referred to as a quick-return mirror, and is rotatably provided within the camera body 2 in order to deflect the optical path of light from the subject side (subject light) that has passed through the interchangeable lens 3. The mirror unit 5 moves to a retracted position (shown by a dashed line in FIG. 1) according to a release operation, and the subject light is directed toward the image pickup device 11.

The viewfinder screen 6 is a screen on which an image of a subject image that has been reflected by the mirror unit 5 is provided, and is disposed between the mirror unit 5 and the pentaprism 7.

The pentaprism 7 is a prism with a pentagonal cross-section for converting the image provided on the viewfinder screen 6 into an upright image, and directing the upright image toward the ocular optical system 8. The pentaprism 7 is placed at an upper portion of the camera body when the camera body 2 is positioned sideways.

The ocular optical system 8 is an optical system for enlarging and observing the subject image that is converted into the upright image by the pentaprism 7. The ocular optical system 8 is provided closer to a rear side (photographer side) of the camera body 2 than the pentaprism 7.

The shutter 9 opens and shuts according to the release operation to control the exposure time, and thus, an image of the subject is formed on the image pickup device 11.

The optical low pass filter 10 is a filter provided along the optical path of the subject light from the interchangeable lens 3, on the subject side of the image pickup device 11, and between the shutter 9 and the image pickup device 11. Details of the optical low pass filter 10 will be described later.

The image pickup device 11 is a CCD, for example, that picks up an image of the subject image that is imaged by the photographic optical system. The image pickup device 11 is provided on the rear side (right side in FIG. 1) within the camera body 2 so that the imaging area is orthogonal to the optical path.

The display screen 12 is a display panel such as liquid crystal panel provided outside of the rear side (photographer side) of the camera body 2. The subject image that has been imaged and information relating to photographing such as exposure time are displayed on the display screen 12.

With the above described camera 1, when the release operation is performed, the mirror unit 5 moves to the retracted position shown by the dashed line in FIG. 1. The shutter 9 opens and shuts according to the release operation, and the subject light is transmitted through the optical low pass filter 10 to form an image on the image pickup device 11, whereby taking a photograph is completed.

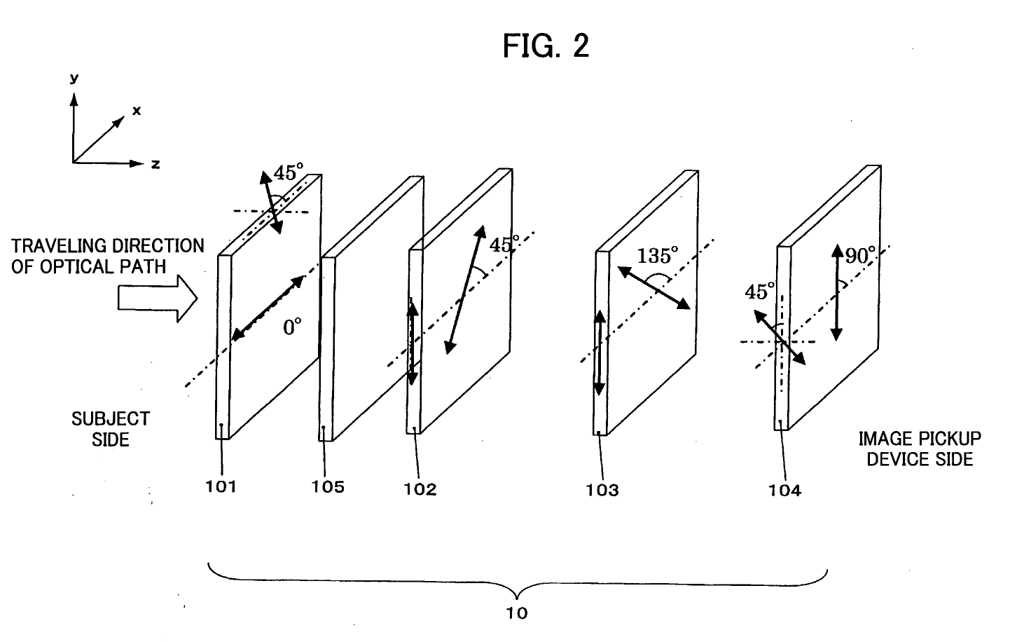

FIG. 2 shows a perspective view illustrating a layer structure of the optical low pass filter 10 and an optical axis of each layer in the layer structure. In FIG. 2, each of the layers is shown separately. Further, in FIG. 2, the x, y, and z coordinate axes are set to aid understanding. A positive direction of the z axis indicates the traveling direction along the optical path, and the x axis and y axis that are orthogonal to each other are set along a plane orthogonal to the z axis. A positive direction of the y axis is upward along a vertical direction when the camera body 2 is positioned sideways, and a positive direction of the x axis is on the right hand for the photographer when the camera body 2 is held sideways. Although the x axis and the y axis are defined as above in the present embodiment, the direction of the optical axis of the optical low pass filter 10 can rotate about the optical path.

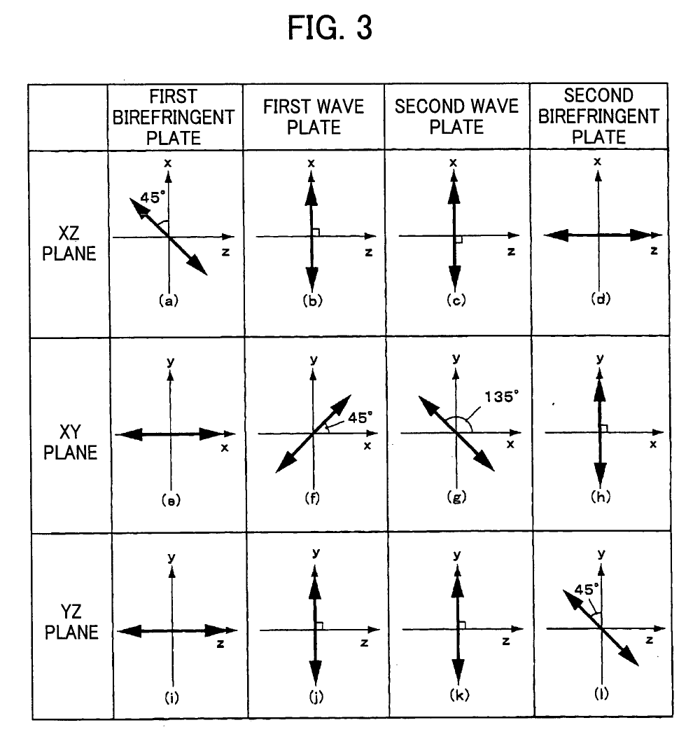

FIG. 3 shows a diagram illustrating an angle of the optical axis of each layer of the optical low pass filter 10. In FIG. 3, (a) to (l) respectively illustrate the optical axes of birefringent plates and wave plates in a plane expressed by the x, y, and z coordinates shown in FIG. 2. In FIG. 3, (a) to (d) each shows an optical axis in an x-z plane, (e) to (h) each shows an optical axis in an x-y plane, and (i) to (l) each shows an optical axis in a y-z plane.

The optical low pass filter 10 is a filter with the functions of removing light of undesired wavelengths that is not used for photographing, and of splitting the subject light that is incident into four beams to suppress Moire effects and the like. The optical low pass filter 10 is configured by a first birefringent plate 101, an infrared cut glass 105, a first wave plate 102, a second wave plate 103, and a second birefringent plate 104 that are laminated.

The first birefringent plate 101 is formed of quartz, and is disposed at a position closest to the subject. The first birefringent plate 101 splits the incident light into two linearly polarized light beams whose oscillation directions are orthogonal to each other.

The first birefringent plate 101 has its optical axis in a plane that is not orthogonal to the traveling direction of the optical path. The optical axis refers to an axis that represents a direction along which a refractive index is constant and birefringence does not occur in a birefringent crystal. The definition is the same throughout the following description and the appended claims. Light that is incident along this optical axis has no birefringence, and therefore the traveling directions of ordinary rays and extraordinary rays that are usually split coincide or deviations between the ordinary ray and the extraordinary ray are minimal. In addition, this optical axis is different from the light axis connecting the central points of the photographic lens 4 and the like that constitute the photographic optical system.

The optical axis of the first birefringent plate 101 is, as shown in (a), (e), and (i) of FIG. 3, along the plane that is not orthogonal to the traveling direction of the optical path (within the x-z plane) and forms an angle of 45 degrees with the x axis.

The infrared cut glass 105 is, in the present embodiment, provided between the first birefringent plate 101 and the first wave plate 102, and absorbs light having wavelength longer than infrared light, that are not necessary for photographing.

The infrared cut glass 105 has no birefringence. Accordingly, an optical axis of the infrared cut glass 105 is not shown in FIG. 2 and FIG. 3.

Further, the present embodiment shows an example in which the infrared cut glass 105 is provided between the first birefringent plate 101 and the first wave plate 102. However, the present invention is not limited to such an example. The infrared cut glass 105 may be provided at a position closest either to the subject or to the image pickup device in the optical low pass filter 10. Alternatively, the infrared cut glass 105 may be provided between the first wave plate 102 and the second wave plate 103, or between the second wave plate 103 and the second birefringent plate 104. The position of the infrared cut glass 105 is not particularly limited.

The first wave plate 102 is formed of quartz, and provided on a side closer to the image pickup device 11 than the first birefringent plate 101. The first wave plate 102 causes the phase difference between two components of the incident light whose oscillation directions are orthogonal to each other, and converts the incident light (linearly polarized light) into circularly polarized light.

An optical axis of the first wave plate 102 is, as shown in (b), (f), and (j) of FIG. 3, within a plane that is orthogonal to the traveling direction of the optical path (x-y plane), and forms an angle of 45 degrees with the x axis.

Further, the optical axis of the first wave plate 102 forms an angle of 45 degrees with the optical axis of the first birefringent plate 101, viewed from the traveling direction of the optical path (within x-y plane) (see (e) and (f) in FIG. 3).

The second wave plate 103 is formed of quartz, and is provided closer to the subject than the first wave plate 102. The second wave plate 103 causes the phase difference between two components contained in the incident light whose oscillation directions are orthogonal to each other, and converts the incident light (linearly polarized light) into circularly polarized light.

The optical axis of the second wave plate 103 is, as shown in (c), (g), and (k) of FIG. 3, within a plane orthogonal to the traveling direction of the optical path (x-y plane), and forms an angle of 135 degrees with the x axis. Consequently, the optical axis of the first wave plate 102 and the optical axis of the second wave plate 103 are orthogonal within the x-y plane (see (f) and (g) of FIG. 3).

Further, the first wave plate 102 and the second wave plate 103 are different in thickness in the direction of the optical path.

The second birefringent plate 104 is formed of quartz, and is provided on a side closer to the image pickup device 11 than the second wave plate 103. The second birefringent plate 104 splits the incident light into two linearly polarized light beams whose oscillation directions are orthogonal to each other.

The optical axis of the second birefringent plate 104 is, as shown in (d), (h), and (l) of FIG. 3, along the plane that is not orthogonal to the traveling direction of the optical path (within y-z plane) and forms an angle of 45 degrees with the y axis.

The thickness of the first wave plate 102 and the thickness of the second wave plate 103 in the direction of the optical path are respectively d1 and d2, and the thickness difference in the direction of the optical path is Δd=|d1−d2|, and where the difference between a refractive index of the ordinary ray and a refractive index of the extraordinary ray due to birefringence of quartz is Δn, the central wavelength of the wavelength range of the subject light used for photographing (hereinafter referred to as wavelength range of use) is λ, and Equation 1 as follows represents the thickness difference between the first wave plate 102 and the second wave plate 103 in the direction of the optical path of the present embodiment.

Δd≈λ/(4*Δn) (Equation 1)

When forming an ideal wave plate (quarter-wave plate) with a single quartz plate, a thickness D of the ideal wave plate is obtained by an equation 2 as follows.

D=λ/(4*Δn) (Equation 2)

That is, the thickness difference Δd between the first wave plate 102 and the second wave plate 103 in the direction of the optical path of the present embodiment is approximately equal to the thickness D of the ideal wave plate.

Here, the central wavelength is the wavelength for which most care is taken (that is, the most emphasized). Typically, the central wavelength is present in the vicinity of green light (about 500 nm to 550 nm) in a case of the optical wavelength range, and thus in the vicinity of the center of the wavelength range of use.

When the wavelength range of use is the optical wavelength range, and its central wavelength λ=550 nm, and the difference between the refractive index of the ordinary ray and the refractive index of the extraordinary ray in quartz is 0.0091, the thickness of the ideal wave plate is obtained by substituting these values for the variables in the equation 2, as follows.

D=550×10⁻⁹/(4×0.0091)≈15 μm

Producing a quartz plate having a thickness of approximately 15 μm is not easy, and not practical in terms of costs and the like. Accordingly, in the present embodiment, the first wave plate 102 and the second wave plate 103 are arranged so that the optical axes of these plates are orthogonal, and the thickness difference Δd in the direction of the optical path is set so as to satisfy Equation 1. With this configuration, a phase difference caused in a portion where the first wave plate 102 and the second wave plate 103 are equal in thickness is canceled. Thus, only a phase difference due to the thickness difference Δd remains.

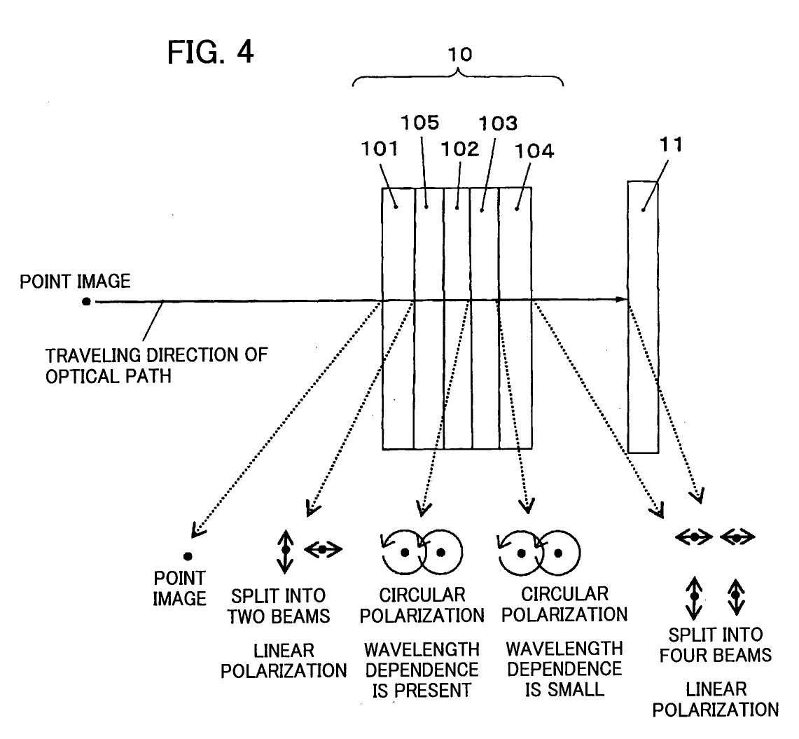

FIG. 4 shows a diagram illustrating the optical low pass filter 10 according to the present embodiment and light that has passed through each layer. In FIG. 4, for simplicity, the case in which the subject is a point image is illustrated.

The subject light first enters the first birefringent plate 101. Due to the birefringence, the subject light is split into two linearly polarized light beams whose oscillation directions are orthogonal to each other, and exits from the first birefringent plate 101.

The subject light as the two linearly polarized light beams then enters the infrared cut glass 105. The infrared cut glass 105 has no birefringence, and has no effect on the polarization state or the phase difference of the subject light.

The subject light that has exited from the infrared cut glass 105 enters the first wave plate 102. Because the first wave plate 102 causes the phase difference between two components of the incident light whose oscillation directions are orthogonal, the subject light exits from the first wave plate 102 as two circularly polarized light beams. However, there is a wavelength dependence in the circular polarization of the first wave plate 102, and accordingly, the circular polarization of one portion of the wavelength range of the used wavelength range of the subject light is incomplete.

The subject light that has exited from the first wave plate 102 enters the second wave plate 103. The optical axis of the second wave plate 103 is orthogonal to the optical axis of the first wave plate 102 within the plane orthogonal to the traveling direction of the optical path, and there is the thickness difference Δd in the direction of the optical path of the subject light between the first wave plate 102 and the second wave plate 103. As a result, the phase difference that has been caused in the portion where the first wave plate 102 and the second wave plate 103 are equal in thickness is canceled, and thus, only the phase difference due to the thickness difference Δd remains. Specifically, the first wave plate 102 and the second wave plate 103 have the same effect obtained when a single wave plate whose thickness is equal to Δd is provided for the subject light.

Here, the thickness difference Δd in the direction of the optical path between the first wave plate 102 and the second wave plate 103 satisfies Equation 1, the first wave plate 102 and the second wave plate 103 has an effect as an ideal wave plate without wavelength dependence on the subject light. Accordingly, the subject light that has exited from the second wave plate 103 becomes two circularly polarized light beams throughout the entire used wavelength range.

The subject light which becomes the two circularly polarized light beams enters the second birefringent plate 104. The two circularly polarized light beams are respectively split into two linearly polarized light beams whose oscillation directions are orthogonal to each other. The subject light as four linearly polarized light beams then exits from the second birefringent plate 104 to enter the image pickup device 11.

An example of the optical low pass filter 10 according to the present embodiment and a comparison example of a conventional optical low pass filter were prepared to study the phase difference and the like due to the wave plate.

The optical low pass filter 10 according to the example is such that the thickness d1 of the first wave plate 102 is 0.15 mm and the thickness d2 of the second wave plate 103 is 0.165 mm. The thickness difference Δd between the first wave plate 102 and the second wave plate 103 is |0.15−0.0165|, which is in turn equal to 0.015 mm, which is in turn equal to 15 μm. This satisfies Equation 1. Producing the first wave plate 102 with the thickness d1 of 0.15 mm and the second wave plate 103 with the thickness d2 of 0.165 mm can be easily achieved using a conventional processing technique.

The optical low pass filter according to the comparison example has a substantially similar configuration to the optical low pass filter 10 of the present embodiment. However, a single quartz plate with a thickness d3 of 0.3 mm is used as the wave plate. The wave plate used in the optical low pass filter according to the comparison example is widely used in conventional optical low pass filters. The thickness d3 of 0.3 mm of the wave plate according to the comparison example is not the minimum thickness available in manufacturing, but an appropriate thickness for an optical low pass filter selected because the effect of the wavelength dependence is relatively small.

Further, in the example of the optical low pass filter 10, the total thickness of the first wave plate 102 and the second wave plate 103 is 0.315 mm, which is substantially the same as the thickness d3 of the wave plate used for the optical low pass filter according to the comparison example, which is 0.3 mm.

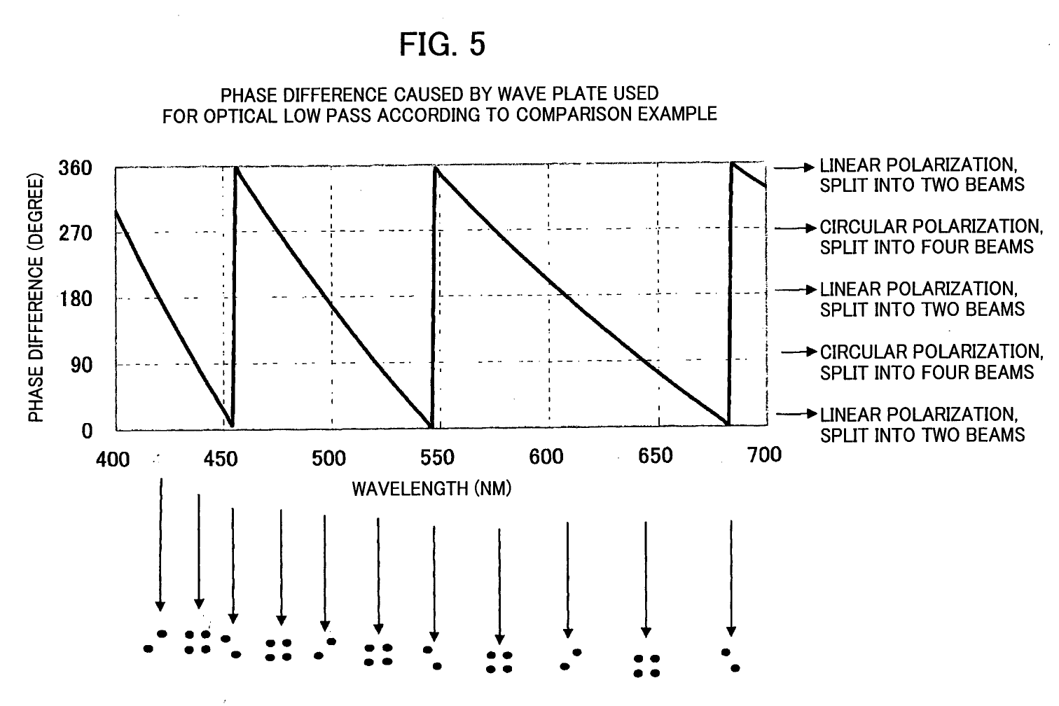

FIG. 5 shows a diagram illustrating the phase difference caused by a wave plate used for an optical low pass according to the comparison example, and the subject light entering the image pickup device.

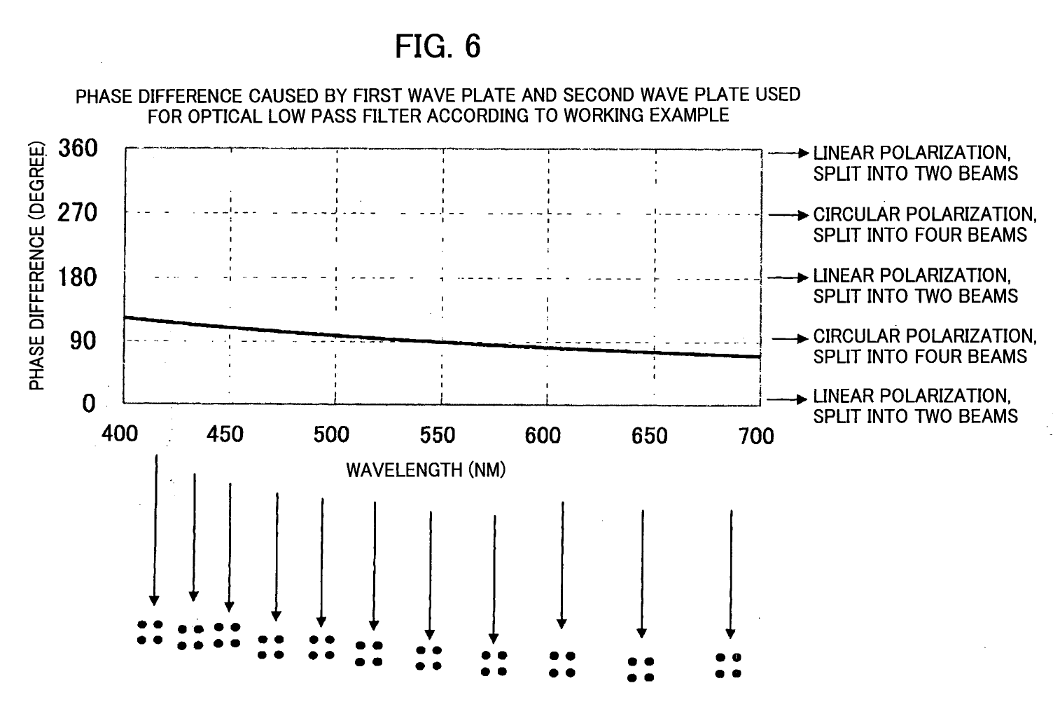

FIG. 6 shows a diagram illustrating the phase difference caused by the first wave plate 102 and the second wave plate 103 used for the optical low pass filter 10 according to the example, and the subject light entering the image pickup device.

In FIG. 5 and FIG. 6, the ordinate axis represents the phase differences caused by the corresponding wave plate, and the abscissa axis represents the wavelengths of the incident light. Further, dots shown below the abscissa axis represent the number of beams the incident light of the wavelength is split into by the corresponding optical low pass filter.

In order to act as an ideal wave plate without wavelength dependence on the subject light that has been turned into the linearly polarized light by the first birefringent plate 101 so as to convert the subject light into the circularly polarized light, the phase difference caused by the wave plate should be either 90 degrees or 270 degrees regardless of the wavelength of the incident light.

However, as shown in FIG. 5, in the wave plate used for the optical low pass filter according to the comparison example, the phase difference that arises varies according to the wavelength. Thus, depending on the wavelength of the subject light that has entered, the subject light is not split into four beams but only into two beams after passing through the optical low pass filter according to the comparison example. As a result, Moire effects can easily occur for a color in a wavelength range that is not split into four beams.

On the other hand, as shown in FIG. 6, in the first wave plate 102 and the second wave plate 103 used for the optical low pass filter 10 according to the example, the phase difference caused by the two wave plates is approximately 90 degrees regardless of the wavelength of the incident light. Thus, the subject light can be split into four beams regardless of the wavelength of the subject light, and it is possible to effectively prevent Moire effects.

As described above, according to the present embodiment, an ideal optical low pass filter with decreased wavelength dependence can be obtained, and the subject light can be split into four beams regardless of the wavelength of the subject light. Consequently, it is possible to suppress Moire effects effectively.

Further, according to the present embodiment, the optical axes are orthogonal within the plane orthogonal to the traveling direction of the optical path, and the first wave plate 102 and the second wave plate 103 where the thickness difference Δd in the direction of the optical path satisfies the equation 1 are laminated. Thus, it is possible to reduce manufacturing costs and to realize a wave plate with reduced wavelength dependence easily, because it is not necessary to use a quartz plate that is processed to be thin enough to have the thickness of an ideal wave plate, and because it is possible to use a first wave plate 102 and a second wave plate 103 with thicknesses that can be easily obtained by processing.

Further, according to the optical low pass filter 10 of the present embodiment, the two wave plates of the first wave plate 102 and the second wave plate 103 are laminated, and the total thickness of these two wave plates is approximately equal to the thickness of the conventionally employed wave plate, and the total thickness of the optical low pass filter is not increased.

Moreover, the first wave plate 102 and the second wave plate 103 are made of quartz, and thus are excellent in durability.

### MODIFIED EXAMPLES

Without being limited to the above described embodiment, various modifications and alterations are possible, and such modifications and alterations are also within the scope of the present invention.

(1) The present embodiment shows an example in which the first wave plate 102 and the second wave plate 103 are laminated adjoining each other. However, the present invention is not limited to this embodiment, and the first wave plate 102 and the second wave plate 103 can be laminated without adjoining each other. For example, the infrared cut glass 105 or the like can be provided between the first wave plate 102 and the second wave plate 103.

(2) In the present embodiment, the thickness difference Δd in the direction of the optical path between the first wave plate 102 and the second wave plate 103 satisfies Equation 1. However, the present invention is not limited to this embodiment, and the thickness difference, can be an odd multiple of Δd represented by Equation 1. Note that the thickness difference between the first wave plate 102 and the second wave plate 103 is preferably not greater than three times Δd represented by the equation 1, because the smaller the difference is, the less the wavelength dependence of the wave plate is.

(3) In the present embodiment, an example is shown in which the first wave plate 102 and the second wave plate 103 are made of quartz. However, the present invention is not limited to this example, and other uniaxial crystals can be used, for example, lithium niobate (LiNbO₃) or the like.

(4) In the present embodiment, an example is shown in which the optical axis of the second wave plate 103 is orthogonal to the optical axis of the first wave plate 102 within the plane orthogonal to the traveling direction of the optical path. Although it is preferable that the angle formed by the optical axis of the first wave plate 102 and the optical axis of the second wave plate 103 within the plane orthogonal to the traveling direction of the optical path is 90 degrees, the subject light can be split into four beams even if there is some tolerance in the arrangement, provided that the thickness of the first wave plate 102 and the second wave plate 103 are sufficiently thin.

(5) In the present embodiment, an example is shown in which the thickness d1 of the first wave plate 102 is 0.15 mm, and the thickness d2 of the second wave plate 103 is 0.165 mm. However, the thicknesses of these plates are not particularly limited to the above values as long as the thickness difference Δd between the first wave plate 102 and the second wave plate 103 satisfies Equation 1.

(6) In the present embodiment, an example is shown in which the light that exits from the first birefringent plate 101 and the second birefringent plate 104 is linearly polarized, and the light that exits from the first wave plate 102 and the second wave plate 103 is circularly polarized. However, the present invention is not limited to this example, and, as long as Moire effects can be prevented, the light exiting the first birefringent plate 101 and the second birefringent plate 104 does not necessarily have to be completely linearly polarized, and may include components other than linearly polarized light, for example. In addition, the light that exits from the first wave plate 102 and the second wave plate 103 may be elliptically polarized and the like instead of completely circularly polarized.

(7) In the present embodiment, a single-lens reflex camera is shown as the camera 1 that can be provided with the optical low pass filter 10. However, the present invention is not particularly limited to this. The optical low pass filter 10 can be provided for, for example, a digital still camera or a digital video camera into which a lens is integrally assembled, or the like.

What is claimed is:

1. An optical low pass filter provided closer to a subject than an image pickup device along an optical path of a photographic optical system, the optical low pass filter comprising:
a first birefringent plate that is provided closest to the subject and that splits incident light into two light beams;
a first wave plate and a second wave plate that are provided on a side closer to the image pickup device than the first birefringent plate, and that cause a phase difference between two components that are contained in the incident light and that have oscillation directions orthogonal to each other; and
a second birefringent plate that is provided on a side closer to the image pickup device than the first wave plate and the second wave plate, and that splits the incident light into two beams.

2. An optical low pass filter provided closer to a subject than an image pickup device along an optical path of a photographic optical system, the optical low pass filter comprising:
a first birefringent plate that is provided closest to the subject and that converts incident light into approximately linearly polarized light;
a first wave plate and a second wave plate that are provided on a side closer to the image pickup device than the first birefringent plate, and that convert the incident light into approximately circularly polarized light; and
a second birefringent plate that is provided on a side closer to the image pickup device than the first wave plate and the second wave plate, and that converts the incident light into approximately linearly polarized light.

3. An optical low pass filter provided closer to a subject than an image pickup device along an optical path of a photographic optical system, the optical low pass filter comprising:
a first birefringent plate that is provided closest to the subject and that has an optical axis along a plane that is not orthogonal to a traveling direction of the optical path;
a first wave plate and a second wave plate that are provided on a side closer to the image pickup device than the first birefringent plate, and each of which has an optical axis along a plane orthogonal to the traveling direction of the optical path; and
a second birefringent plate that is provided on a side closer to the image pickup device than the first wave plate and the second wave plate, and that has an optical axis along the plane that is not orthogonal to the traveling direction of the optical path.

4. The optical low pass filter according to claim 1, wherein
an optical axis of the first wave plate and an optical axis of the second wave plate are approximately orthogonal within a plane orthogonal to a traveling direction of the optical path.

5. The optical low pass filter according to claim 2, wherein
an optical axis of the first wave plate and an optical axis of the second wave plate are approximately orthogonal within a plane orthogonal to a traveling direction of the optical path.

6. The optical low pass filter according to claim 3, wherein
the optical axis of the first wave plate and the optical axis of the second wave plate are approximately orthogonal within the plane orthogonal to the traveling direction of the optical path.

7. The optical low pass filter according to claim 1, wherein
an equation Δd≈λ/(4*Δn) is satisfied, where
a thickness difference between the first wave plate and the second wave plate in a direction of the optical path is Δd,
a difference between a refractive index of an ordinary ray and a refractive index of an extraordinary ray of the first wave plate and the second wave plate is Δn, and
a central wavelength of a wavelength range of use is λ.

8. The optical low pass filter according to claim 2, wherein
an equation Δd≈λ/(4*Δn) is satisfied, where
a thickness difference between the first wave plate and the second wave plate in a direction of the optical path is Δd,
a difference between a refractive index of an ordinary ray and a refractive index of an extraordinary ray of the first wave plate and the second wave plate is Δn, and
a central wavelength of a wavelength range of use is λ.

9. The optical low pass filter according to claim 3, wherein
an equation Δd≈λ/(4*Δn) is satisfied, where
a thickness difference between the first wave plate and the second wave plate in a direction of the optical path is Δd,
a difference between a refractive index of an ordinary ray and a refractive index of an extraordinary ray of the first wave plate and the second wave plate is Δn, and
a central wavelength of a wavelength range of use is λ.

10. The optical low pass filter according to claim 1, wherein
an optical axis of the first birefringent plate and an optical axis of the first wave plate form an angle of approximately 45 degrees when viewed from a traveling direction of the optical path.

11. The optical low pass filter according to claim 2, wherein
an optical axis of the first birefringent plate and an optical axis of the first wave plate form an angle of approximately 45 degrees when viewed from a traveling direction of the optical path.

12. The optical low pass filter according to claim 3, wherein
the optical axis of the first birefringent plate and the optical axis of the first wave plate form an angle of approximately 45 degrees when viewed from the traveling direction of the optical path.

13. The optical low pass filter according to claim 1, wherein
the first wave plate and the second wave plate are formed of quartz, and
a thickness difference between the first wave plate and the second wave plate in a direction of the optical path is approximately 15 μm.

14. The optical low pass filter according to claim 2, wherein
the first wave plate and the second wave plate are formed of quartz, and
a thickness difference between the first wave plate and the second wave plate in a direction of the optical path is approximately 0.15 μm.

15. The optical low pass filter according to claim 3, wherein
the first wave plate and the second wave plate are formed of quartz, and
a thickness difference between the first wave plate and the second wave plate in a direction of the optical path is approximately 15 μm.

16. A camera including an optical low pass filter provided closer to a subject than an image pickup device along an optical path of a photographic optical system, the optical low pass filter comprising:
a first birefringent plate that is provided closest to the subject and that splits incident light into two light beams;
a first wave plate and a second wave plate that are provided on a side closer to the image pickup device than the first birefringent plate, and that cause a phase difference between two components of the incident light whose oscillation directions are orthogonal; and
a second birefringent plate that is provided on a side closer to the image pickup device than the first wave plate and the second wave plate, and that splits the incident light into two beams.

17. A camera including an optical low pass filter provided closer to a subject than an image pickup device along an optical path of a photographic optical system, the optical low pass filter comprising:
a first birefringent plate that is provided closest to the subject and that converts incident light into approximately linearly polarized light;
a first wave plate and a second wave plate that are provided on a side closer to the image pickup device than the first birefringent plate, and that convert the incident light into approximately circularly polarized light; and
a second birefringent plate that is provided on a side closer to the image pickup device than the first wave plate and the second wave plate, and that converts the incident light into approximately linearly polarized light.

18. A camera including an optical low pass filter provided closer to a subject than an image pickup device along an optical path of a photographic optical system, the optical low pass filter comprising:
a first birefringent plate that is provided closest to the subject and that converts incident light into approximately linearly polarized light;
a first wave plate and a second wave plate that are provided on a side closer to the image pickup device than the first birefringent plate, and that convert the incident light into approximately circularly polarized light; and
a second birefringent plate that is provided on a side closer to the image pickup device than the first wave plate and the second wave plate, and that converts the incident light into approximately linearly polarized light.
